(19) United States
(12) Patent Application Publication
(10) Pub. No.: US 2015/0198719 A1
(43) Pub. Date: Jul. 16, 2015

(54) RADIO FREQUENCY POSITION TRANSDUCER

(71) Applicant: Kinze Manufacturing, Inc., Williamsburg, IA (US)

(72) Inventor: John P. Mulherin, Cedar Rapids, IA (US)

(21) Appl. No.: 14/596,570

(22) Filed: Jan. 14, 2015

Related U.S. Application Data
(60) Provisional application No. 61/927,241, filed on Jan. 14, 2014.

(51) Int. Cl. G01S 19/46; G01C 3/08; G01S 5/16; G01S 5/14

(52) U.S. Cl. CPC G01S 19/46; G01S 5/14; G01C 3/08; G01S 5/16

(57) ABSTRACT

A positioning system and method of determining a position of a mobile unit is provided. The system and method include the use of radio frequency signals transmitted between the mobile unit and multiple base units having known and fixed locations. The signals will be transmitted from and returned to the mobile unit to determine a phase shift of the signal in order to determine the distance between the two. The process can be repeated between the mobile unit and each of the base units in order to acquire a continuously updated location of the mobile unit relative to the base units. Additionally, optics and GPS can be included to acquire additional distance readings for comparison and to more accurately determine the location of the mobile unit.

### CROSS REFERENCE TO RELATED APPLICATIONS

This application claims priority under 35 U.S.C. §119 to provisional application Ser. No. 61/927,241, filed Jan. 14, 2014, herein incorporated by reference in its entirety.

### FIELD OF THE INVENTION

The invention relates generally to positioning systems. More particularly, but not exclusively, the invention relates to a positioning system including a radio frequency signal transmitted between a mobile unit and multiple base units to determine the phase shift of the signal to determine the location of the mobile unit relative to the base units.

### BACKGROUND OF THE INVENTION

It is important in many industries, including the agricultural industry, to have an accurate location or positioning system to be able to determine a user's location. Global positioning systems (GPS) have been used with respect to tractors, autonomous vehicles, and other vehicles to determine the location of the vehicle in a field or other area. In a GPS, a number of satellites are placed in orbit around the planet Earth. The GPS satellites are designed to transmit electromagnetic signals. From these electromagnetic signals, the absolute, terrestrial position (position with respect to the Earth's center) of any receiver at or near the Earth's surface can ultimately be determined.

However, global positioning systems such as GPS provide only medium accuracy position information, usually no better than 10 cm, and requires a clear view of the sky to near the horizon. Local positioning systems, with either active or passive components distributed in a working volume, can allow much more accurate positioning, and allows the user to expand the system as necessary to operate in even the most complex enclosed geometries.

Conventional local positioning systems include acoustic and laser ranging systems. Acoustic systems typically use transponder beacons to measure range within a network of devices, some of which are fixed to form the local coordinate system. Unfortunately, because of the properties of sound propagation through air, acoustic systems can only measure range to accuracies of a centimeter or more, and only over relatively short distances. Local positioning systems based on lasers utilize measurements of both the angle and range between a device and one or more reflective objects, such as prisms, to triangulate or trilateralate the position of the device. However, laser systems currently employ expensive pointing mechanisms that can drive the system cost to $30K or more.

Furthermore, other types of time-based or time of flight-based systems have been utilized as well. A problem with time of flight-based positioning systems is that these are limited to the speed of the flight. This can reduce the accuracy of the time of flight positioning systems. Phase arrays have also been utilized as positioning systems, but these tend to be very complex.

Therefore, there is a need in the art for an easy to use and accurate positioning system that can be incorporated into agricultural vehicles, autonomous vehicles, and other vehicles.

### SUMMARY OF THE INVENTION

The invention differs from earlier attempts to solve the problem of locating an agricultural machine in that it adapts a phase-shifted range finding method commonly applied to optical range finders to a radio frequency implementation intended for agricultural applications.

As such, it is one object, feature, and/or advantage of the invention to locate a vehicle without the need for line-of-sight transmission and reception, and without complete dependency on unreliable GPS signals or uncontrolled subscription services.

According to an embodiment of the invention, a radio frequency range finding system is provided. The methods used in optical range finding will be adapted for use in the radio frequency spectrum. Instead of measuring the phase shift of an amplitude-modulated signal at a given frequency, the phase shift between a reference signal and a locating signal will be measured directly, i.e. the amplitude of the radio frequency signal will not vary in time. The system will be used to provide accurate position data with sufficient resolution to agricultural machinery. The system will provide this position information without a need for line-of-site interaction with the radio frequency transmitter/receiver units. The intent is to provide accurate position data to the end user that is 100% reliable and 100% under the end user's control, as opposed to GPS based or subscription services.

Accordingly, a system will be provided that comprises a minimum of four transmitter/receiver (transceiver) pairs. At least three transceivers will be located on base stations fixed to the ground in known locations. One transceiver will be mounted to a mobile unit whose position is desired. For example, the mobile unit may be a unit affixed or otherwise included with a tractor or other vehicle or implement. The transceiver on the mobile unit will transmit a signal to activate one of the base station transceivers, deactivating the remainder. A tone in the radio frequency spectrum at a predetermined frequency will be sent to the base station, and the base station will receive and rebroadcast the tone to the mobile unit transceiver. This returned signal will be compared to the reference signal transmitted from the mobile unit to determine the phase shift due to the separation between the mobile unit and the base station. This phase shift will be used to determine one of the components of the range to the base station. The transmit/receive interaction will be repeated several times at different radio frequencies to disambiguate the range information, eventually reaching the spatial resolution required.

Once the range between the mobile unit and the first base station is determined, the process will begin again using another of the available base stations. Once accurate range data of sufficient resolution has been acquired from all available base stations, logic on the mobile unit will determine the vehicle's location with respect to the base stations, thus providing the position of the mobile unit.

### BRIEF DESCRIPTION OF THE DRAWINGS

FIG. 1 is a schematic diagram of a positioning system according to an embodiment of the invention.

FIG. 2 is a schematic diagram illustrating the initialization of base units of a positioning system.

FIG. 3 is a schematic diagram illustrating the determination of the position of a mobile unit.

FIG. 4 is a schematic of a phase shift of a radio frequency wave.

FIG. 5 is a block diagram of a mobile unit for use with the positioning system according to an embodiment of the invention.

FIG. 6 is a block diagram of a base unit for use with the positioning system according to an embodiment of the invention.

FIG. 7 is a block diagram showing the interaction between the components of the mobile and base units.

FIG. 8 is a schematic diagram illustrating the determination of the position of a mobile unit.

FIG. 9 is a block diagram of a mobile unit for use with the positioning system according to an embodiment of the invention.

FIG. 10 is a block diagram of a base unit for use with the positioning system according to an embodiment of the invention.

FIG. 11 is a block diagram showing the interaction between the components of the mobile and base units.

FIG. 12 is a schematic diagram illustrating the determination of the position of a mobile unit using optical methods.

FIG. 13 is a schematic diagram illustrating the band pass filter arrangement.

FIG. 14 is a schematic diagram illustrating the camera plane to CPU relationship.

FIG. 15 is a schematic diagram illustrating the determination of the position of a mobile unit using radar methods.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

A positioning system 10 is included. The positioning system 10 utilizes radio frequency signals to aid in determining the position of a vehicle relative to known locations of a plurality of base units 18. For example, a mobile unit 14 may be an agricultural vehicle in a field 12. The agricultural vehicle may be a tractor, autonomous vehicle, truck, implement, or other vehicle. It is important to know the location of the mobile unit 14. The location may be useful for determining a type of product to apply or plant at a particular location of the field 12. In addition, when the mobile unit 14 is an autonomous vehicle, the location is important such that the autonomous vehicle does not travel in an undesired area or collide with another vehicle in the same vicinity.

Therefore, the positioning system 10 utilizes radio frequency signals to aid in determining the position of the mobile unit 14. The radio frequency signals will be used by determining a phase shift between a reference and locating signal to determine a change in location of the mobile unit 14. Radio frequency (RF) spectrum ranges from approximately 3 kHz to 300 GHz. Furthermore, the radio frequency waves can be used in situations where line of sight between the mobile unit 14 and base units is not available. Thus, the radio frequency signals will provide an advantage of being able to be used in greater applications. Furthermore, the use of determining the phase shift of a reference and locating signal radio frequency signal will allow for direct measurement of a change of distance and can determine a sub-inch change in position of the mobile unit 14. The accuracy can be increased by use of more accurate electrical components used to determine the amplitude of the phase shift between the radio frequency signal(s).

As will be understood, the present invention contemplates licensing a section of the radio frequency spectrum from the Federal Communications Commission (FCC). This will ensure that the frequency used in the positioning system 10 will be such that no other system will use the same frequency. This will ensure that there is no contamination or mix up between the radio frequency signals sent and received by the components of the positioning system 10 of the present invention. Therefore, the present invention is not limited to a certain range of frequencies for the use of the positioning system 10, and may be determined upon the availability of certain radios frequency ranges or sections of the RF spectrum according to the FCC.

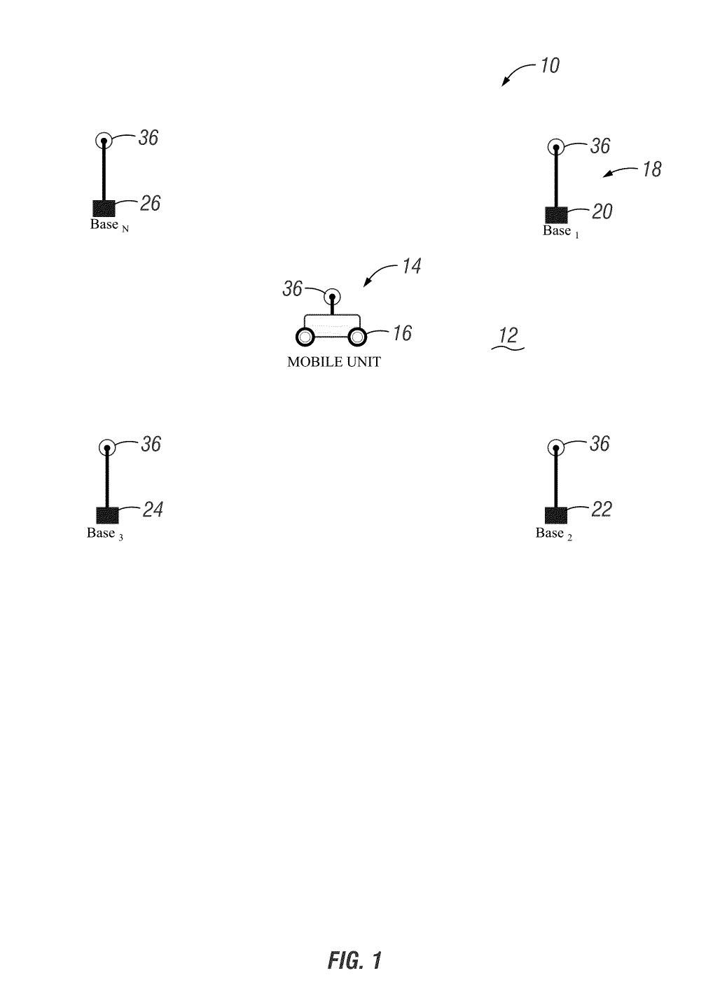

Accordingly, FIG. 1 is a schematic diagram according to an embodiment of a positioning system 10 of the present invention. As shown in FIG. 1, the positioning system 10 will be used in the field 12 or other large area. The positioning system 10 includes at least one mobile unit 14 and a plurality of base units 18. The mobile unit 14, as mentioned, may be an autonomous vehicle or other agricultural vehicle that has wheels or tracks 16 for moving within and around the field 12. The base units 18 will be positioned at known locations and fixed at a these locations in the field 12. According to an embodiment of the present invention, the invention contemplates at least three base units 18 positioned at known locations in and around the field 12, as well at least one mobile unit 14 for use in moving in the field 12. However, as shown in FIG. 1, the positioning system 10 contemplates that any number of base units and mobile units may be utilized within and around the same field for determining the position of one or more mobile units. As such, FIG. 1 shows a first base unit 24, second base unit 22, third base unit 20, and Nth base unit 26. As noted, the base units are fixed at locations in and around the field 12. Furthermore, the designation of the Nth base unit 26 shows that the present invention is not to be limited to a certain number of base units and can include any number of base units at known locations. Furthermore, it should be appreciated that each of the mobile units and base units include or comprise a transceiver 36 operably connected to the unit. The transceiver 36 includes a transmitter 38 and a receiver 40 for sending and receiving radio frequency signals. However, the transmitter and receiver need not comprise a single unit, and can be separate components for a mobile and/or base unit.

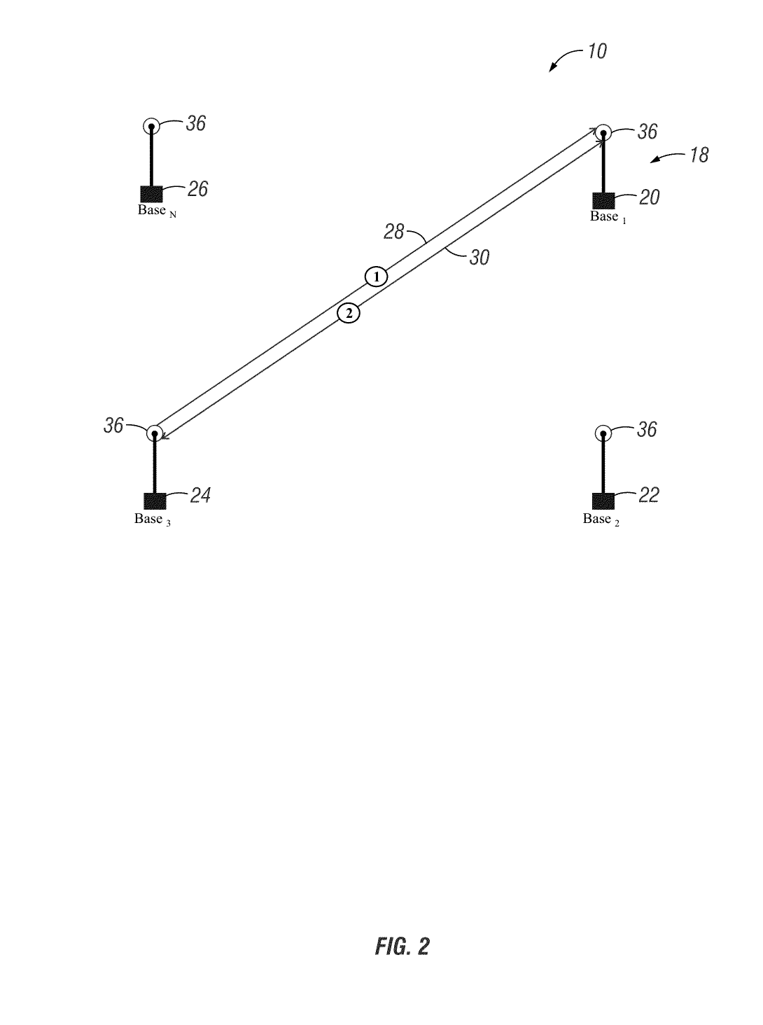

FIG. 2 is a schematic diagram illustrating the initialization of the locations of the plurality of base units 18 of the positioning system 10 in a field 12. To obtain the known locations of each of the plurality of base units 18 in the field 12, the initialization steps will be completed. The process includes the transmission of a radio frequency signal 28 transmitted by a master base unit, which in FIG. 2 is shown to be the third base unit 24. The transmitted radio frequency signal 28 is received by the remaining other base units. The radio frequency signal 28 contains an address of a particular base unit for which the transmitter function of the transceiver 36 on base unit 20 is to be activated. At this point, all of the other base units disable their transmitter function. Once the identified base unit, in FIG. 2 shown to be the first base unit 20, has received the first radio frequency signal 28, the first radio frequency location signal 30 is transmitted by transceiver 36 on base unit 24. Transceiver 36 on base unit 20 receives the radio frequency location signal 30 and then returns the radio frequency location signal 30 back to the master base unit, i.e. the third base unit 24. The process is then repeated at one or more other radio frequencies to achieve disambiguation of range data. This will provide a known distance between the third base unit 24 and the first base unit 20. As will be understood, the base units will include an intelligent control 42, such as a logic processor or central processing unit (CPU), which also may be a digital/analogue converter, for determining the phase shift of the transmitted and returned radio frequency location signal, which will provide a direct measurement of the distance between the third and first base units 24, 20. Next, the range process of determination relative to other base units is repeated for the base units 2-N 22, 26, based on the master base unit or third base unit 24. The process will determine the distance and location between each of the base units by sending and receiving radio frequency location signals from the master base unit and the additional base units. Therefore, the field is plotted based upon the known locations of the plurality of base units 18. The positioning system 10 is then ready to provide an updated location and position of one or more mobile base units 14 in the field 12.

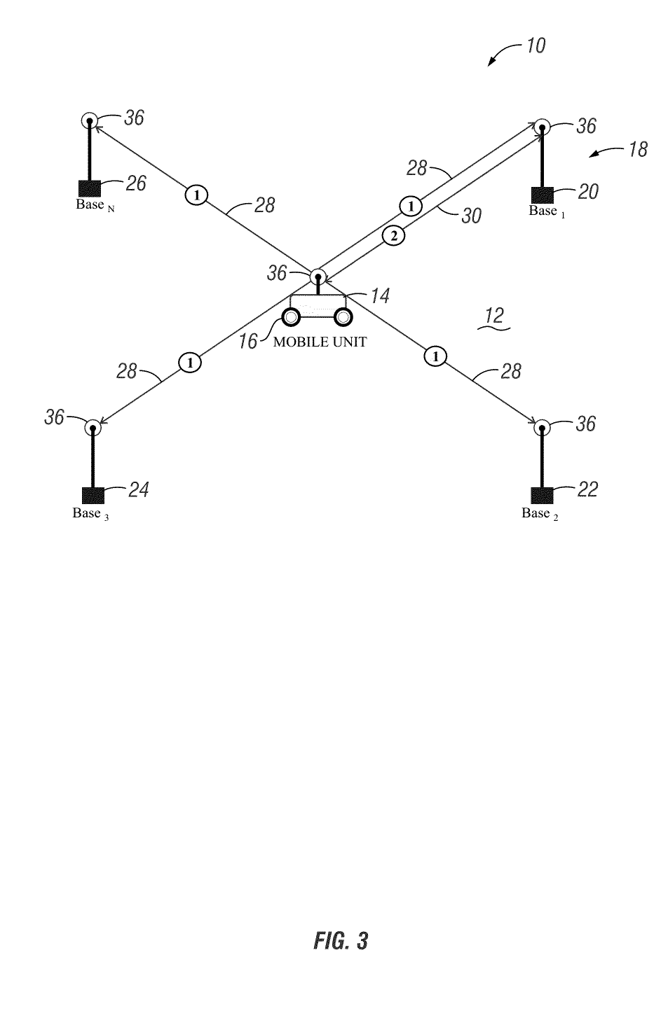

FIG. 3 is a schematic diagram illustrating the determination of a position of a mobile unit 14 by utilization of the positioning system 10 according to an embodiment of the present invention. As noted, the positioning system 10, according to an embodiment, may include a minimum of three base units, with no maximum number. It should be appreciated that a greater number of base units 18 may be used to increase the accuracy of system 10 in determining the location of the mobile unit 14. According to some aspects of the present invention, the base units are fixed in location and each comprise a transmitter, receiver, and control system or intelligent control. Likewise, according to some aspects of the invention, the mobile unit comprises a transmitter 38, receiver 40, and a control system or intelligent control 42. However, it is to be appreciated that any of the units may comprise more or less components, as needed.

To determine the position of the mobile unit 14 by use of the positioning system 10, the following process may be used. The process utilizes a determination of a distance between the mobile unit 14 and each of the plurality of base units 18, which will provide for an updated position of the mobile unit 14 as it moves through the field 12. A first radio frequency signal 28 is transmitted by the mobile unit 14 to each of the plurality of base units 18. The radio frequency signal 28 is received by each of the base units. However, the radio frequency signal 28 contains or includes an address of a particular base unit for which the transmitter function of the transmitter 36 is to be activated. For example, in FIG. 3 the first base unit 20 is the base unit to have its transmitter 36 activated by the first radio frequency signal 28. Each of the additional base units disable their transmitter function based upon the message included in the first radio frequency signal 28. At this point, a second transmission of a radio frequency location signal 30 is sent from the mobile unit 14 to the first base unit 20. This radio frequency location signal 30 is transmitted to and returned by the first or active base unit 20 for a rough calculation of range by the intelligent control 42 of the mobile unit 14. The process is then repeated between mobile unit 14 and base unit 20 at one or more different radio frequencies to achieve disambiguation of range data by the intelligent control 42 of the mobile unit 14. The comparison of transmitting and returning radio frequency signals will provide a phase shift between the outgoing and returning radio frequency signals, which will provide a direct measurement of the distance between the mobile unit 14 and the base unit 20.

Next, the range determination process is repeated for the remaining base units two-N 22, 24, 26. Using the known location of each of the base units, the mobile unit 14 calculates its position based upon the distance between itself and each of the base units using intelligent control 42. As noted, having more base units of known locations will provide for a more accurate location or positioning of the mobile unit 14.

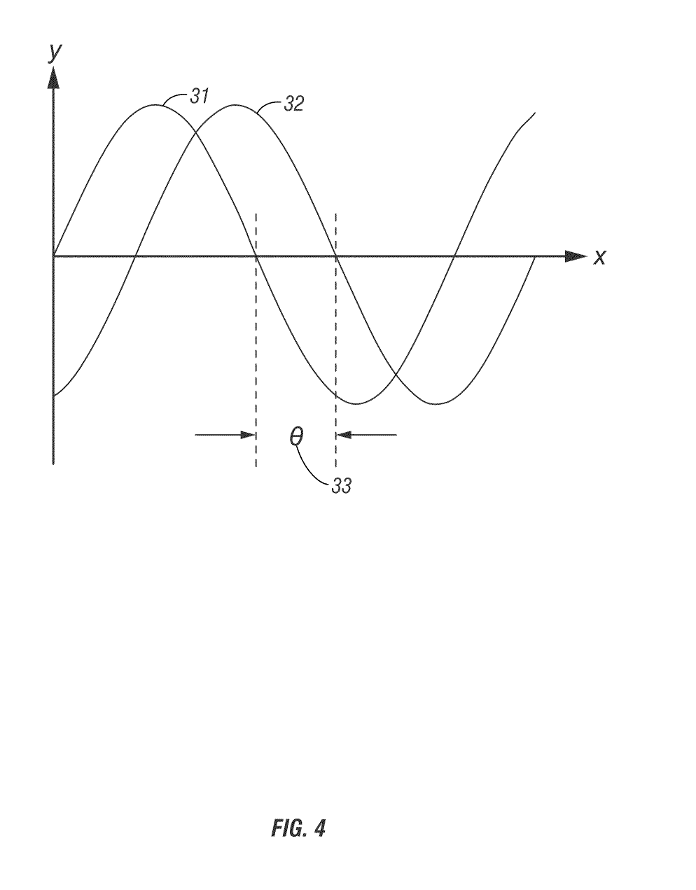

FIG. 4 is a schematic of a graph showing a phase shift of a radio frequency signal overlaid with a radio frequency reference signal. The wave is shown on an x, y-axis graph in FIG. 4. The first radio frequency wave 31 correlates to the transmitted radio frequency reference signal from the mobile unit to one of the base units. The second radio frequency wave 32 correlates to the returned radio frequency signal from the base unit to the mobile unit. The waves take the form of generally sinusoidal waves along the x, y-axis graph. The phase shift between the first and second signals 31, 32 is depicted by angle theta 33. This shift in the waves directly correlates to the distance between the mobile unit and the base unit, and does not rely upon a time-based function, as is used in known positioning systems, i.e. time of flight measurements.

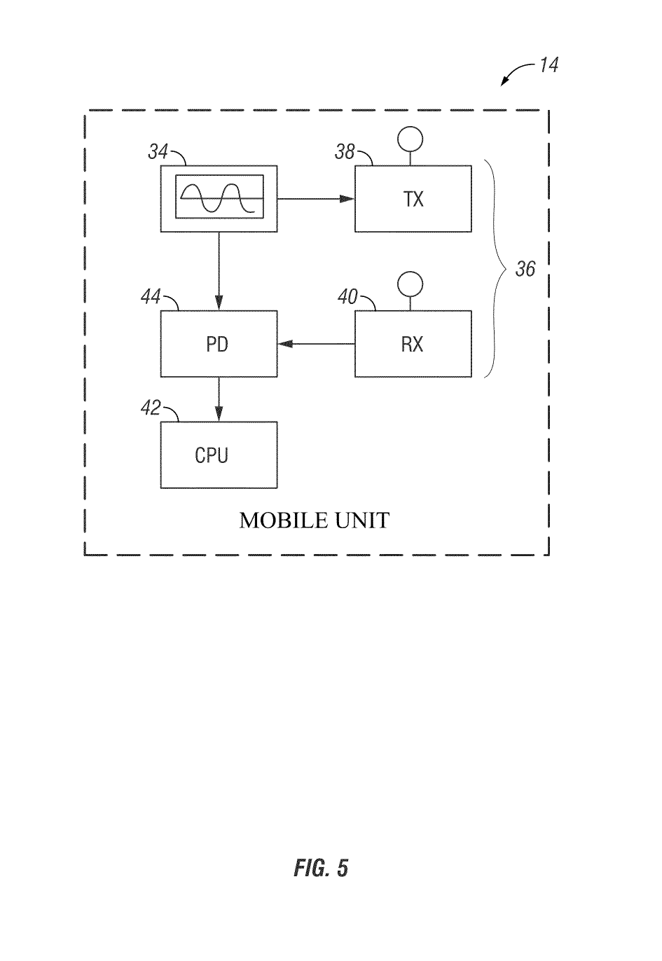

FIG. 5 is a block diagram depicting the components of a mobile unit 14 for use with the positioning system 10 according to an embodiment of the present invention. According to the embodiment shown in FIG. 5, the mobile unit 14 includes or otherwise comprises a frequency generator 34. The frequency generator 34 generates the RF signal to be transmitted from the mobile unit 14 to the base unit 18. The phase generator 34 may be any generator that may be manufactured or purchased off the shelf. The mobile unit also includes a transmitter 38 and a receiver 40. The transmitter and receiver 38, 40 may be incorporated into a single device, which is known as a transceiver 36. The transmitter 38 is operably connected to the frequency generator 34 to transmit the RF signal generated by the frequency generator 34. The receiver 40 is operably connected to a phase detector 44, which detects radio frequency signals that have been received by the receiver 40 from one of the base units. Frequency generator 34 and receiver 40 are operably connected to the phase detector 44. The reference radio frequency signal generated by frequency generator 34 is compared to the radio frequency signal received by receiver 40 by the phase detector 44 to generate a phase difference signal. The intelligent control 42, which may be a CPU or other logic processor, is operably connected to the phase detector 44. The phase difference signal generated by phase detector 44 is interpreted by intelligent control 42 to calculate the distance between mobile unit 14 and base unit 18. The intelligent control 42 can also include memory for storing data related to the position of the mobile unit, and may also store other data related to the transmission and receiving of the RF signals.

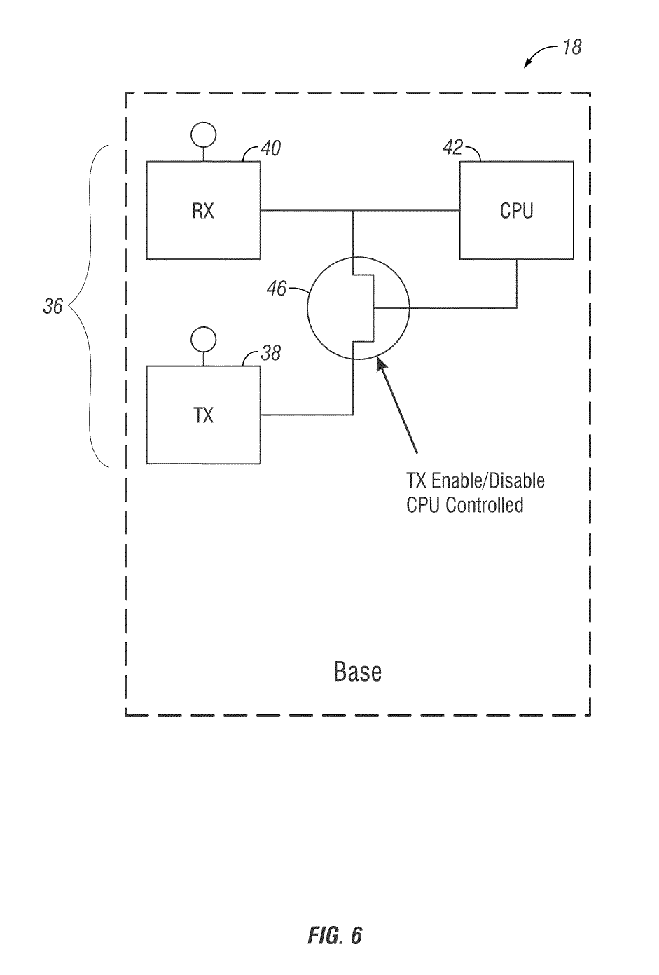

The components of an exemplary base unit 18 according to an embodiment of the positioning system 10 of the present invention are shown in FIG. 6. The base unit of FIG. 6 includes a receiver 40 and a transmitter 38. As should be appreciated, the transmitter 38 and receiver 40 may be included into a single transceiver 36 as well. This can be generally any transceiver as is known in the art. Coupled to the transmitter 38 and receiver 40 is an intelligent control 42, which may be a CPU or other logic processor. Furthermore, the intelligent control may be operably connected or otherwise coupled to the transceiver via a switch 46. The switch 46 includes a transmitter enable/disable switch that is controlled by the intelligent control 42. For example, when a particular base unit receives a signal from the mobile unit and is not to be the particular base unit activated by the signal, the intelligent control 42 can disable the transmitter 38 of the particular base unit by the switch 46, which will prevent the said base unit from transmitting a signal back to the mobile unit. When the base unit receives a particular radio frequency signal from the mobile unit including an address to activate said base unit, the intelligent control 42 can enable the transmitter via the switch 46 to transmit a signal back to the mobile unit via the transmitter 38.

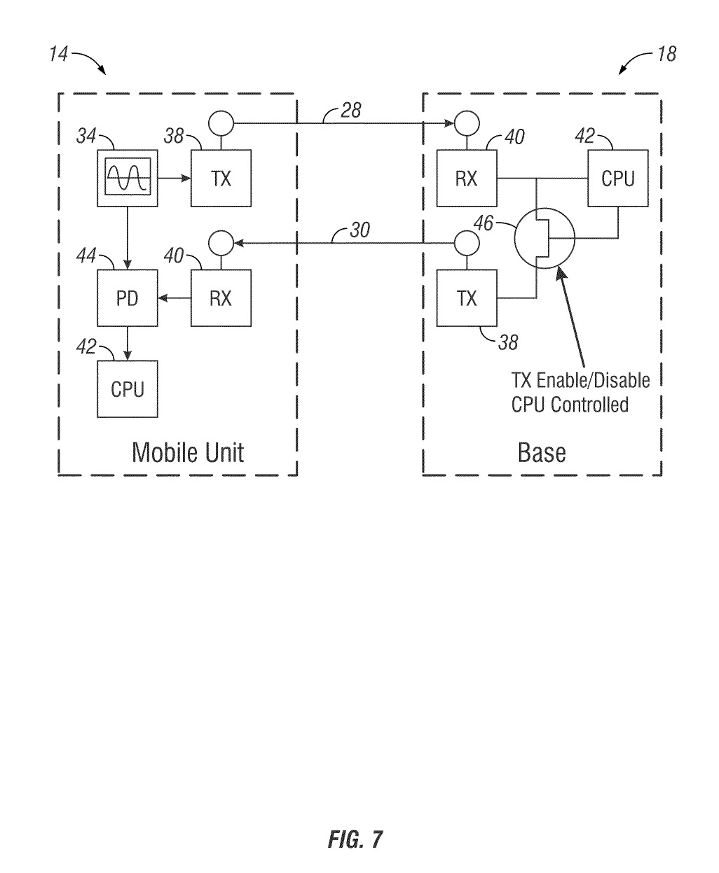

A block diagram showing the interaction between a mobile unit 14 and active base unit 18 is shown in FIG. 7. According to a positioning system 10 of the present invention, the components may interact as follows. A radio frequency signal is generated by the frequency generator 34 of the mobile unit 14. This communicates to the mobile unit transmitter 38 to send a radio frequency signal 28 to each of the base units with an address activating one particular base unit, which is shown as 18 in FIG. 7. The signal 28 is received by the receiver 40 of the unit 18 and is interpreted by the intelligent control 42. As the intelligent control 42 interprets the signal or otherwise reads the signal to determine that it is the base unit to be activated, the intelligent control 42 enables the switch 46 to direct the transmitter of the base unit 18 to send a return signal 30 to the mobile unit 14. This returned signal 30 is received by the receiver 40 of the mobile unit, detected by the phase detector 44 of the mobile unit, and evaluated by the intelligent control 42 of the mobile unit 14. The phase detector 44 and the intelligent control 42 of the mobile unit will determine the phase shift between the transmitted signal 28 and the returned signal 30 to determine the distance between the mobile unit 14 and the known location of the particular base unit 18 that has been activated. As has been mentioned, this process can be repeated at different radio frequencies to disambiguate the distance between the mobile unit and the base unit. Once a location is known, the mobile unit will then send a new signal with an address for a different base unit to determine its distance from said new base unit based upon a phase shift between the sent and received radio frequency signals. The process is repeated until the mobile unit 14 has determined its position relative to each of the known locations of the base units. Thus, the mobile unit 14 will have an accurate depiction of its location in the field 12 or other location.

The use of determining the position by the positioning system 10 of a mobile unit by use of the phase shift of a radio frequency signal provides numerous advantages. As mentioned, this is not a time base system such that it is not limited to the travel time of the radio frequency signal. Thus, the radio frequency signals will provide greater accuracy and precision for determining the position of a mobile unit. Furthermore, the system does not rely on direct line of sight or other ideal conditions for determining the system, instead can be used in generally any condition and location. The positioning system 10 according to the present invention provides for an improved and advantageous way to determine the location of a mobile unit, such an autonomous vehicle or other agricultural vehicle in a field based upon known base locations.

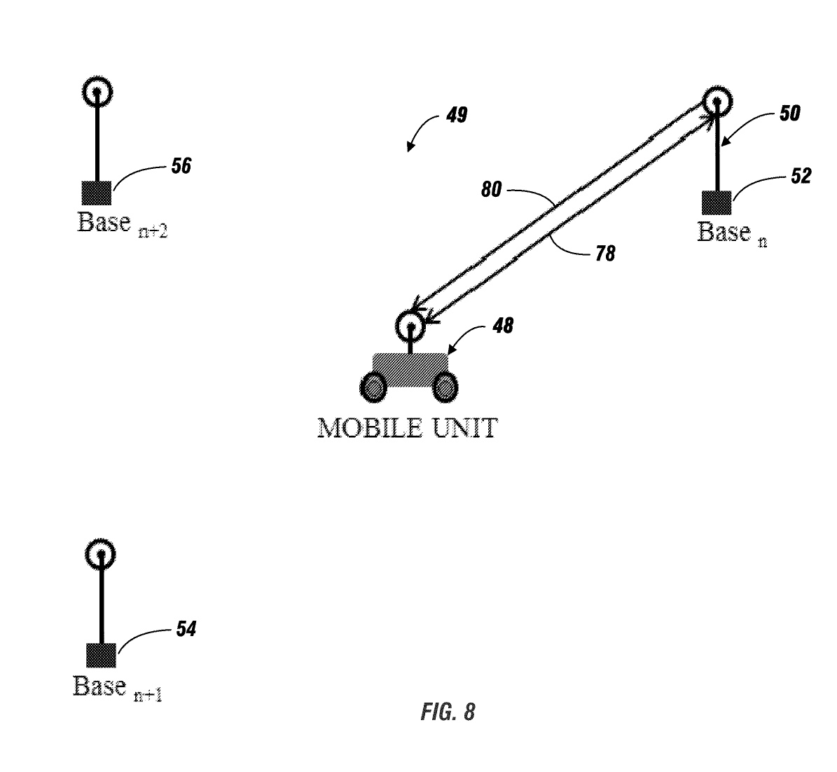

FIG. 8 is a schematic diagram illustrating the determination of a position of a mobile unit 48 by utilization of the positioning system 49 according to an alternate embodiment of the present invention. As noted, the positioning system 49, according to an embodiment, may include a minimum of three base units, with no maximum number. It should be appreciated that a greater number of base units 48 may be used to increase the accuracy of system 49 in determining the location of the mobile unit 48. According to some aspects, the base units are fixed in location, and comprise a standard GPS receiver 70, a control system or intelligent control 72, a communication transceiver 74, and a transmitter for location 76. Likewise, according to some aspects of the invention, the mobile unit comprises a standard GPS receiver 58, a control system or intelligent control 60, a communication transceiver, a reference signal 64, a phase detector 66, and a receiver for location 68. However, it is to be appreciated that any of the units may comprise more or less components, as needed.

To determine the position of the mobile unit 48, the following process may be used. The process utilizes a determination of a range between the mobile unit 48 and each of the plurality of base units 50, which will provide for an updated position of the mobile unit 48 as it moves through the field 12. A first radio frequency signal 78 is transmitted by the mobile unit 48 via a communication transceiver 62 to the communication transceiver 74 to enable the base unit 52. The base unit 52 enables the location transmitter 76 and responds to the mobile unit 48 by sending a second radio frequency 80. The mobile unit 48 receives the location signal 80 from the base unit 52 via the location receiver 68 and compares to a reference signal 64 to generate a phase detector 66 output. The mobile unit 48 uses the phase detector 66 to locate the mobile unit 48 with respect to the base unit 52. The range determination process is repeated for the remaining base units 54, and 56. Using the known location of each of the base units disambiguated by the signal from the standard GPS receivers 58 and 70, the mobile unit 48 calculates its position based upon the distance between itself and each of the base units using the intelligent control 60. As noted, having more base units of known locations will provide for a more accurate location or positioning of the mobile unit 48.

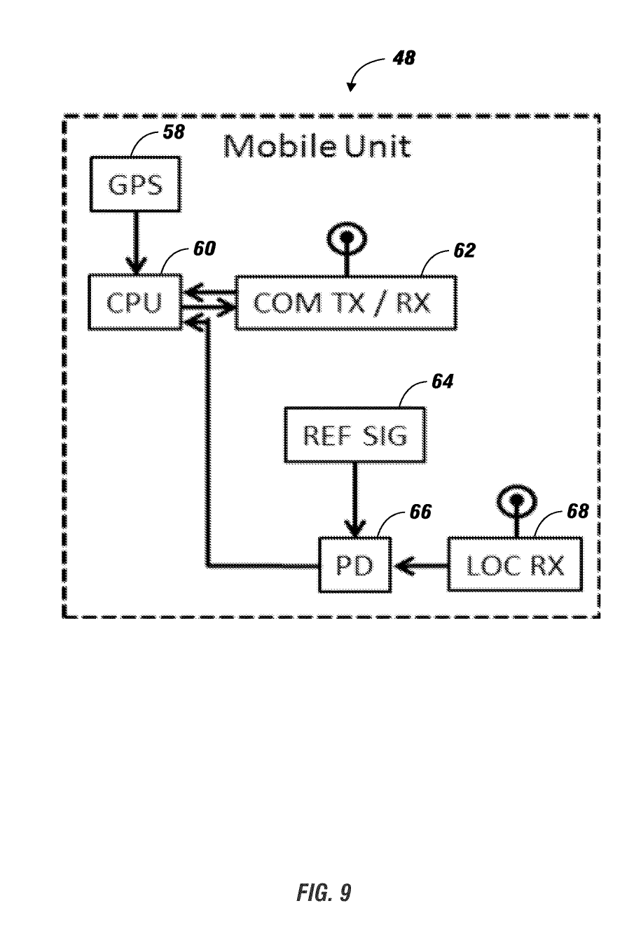

FIG. 9 is a block diagram depicting the components of a mobile unit 48 for use with the positioning system 49 according to some embodiments of the present invention. According to the embodiment shown in FIG. 9, the mobile unit 48 includes or otherwise comprises a standard GPS receiver 58, a control system or intelligent control 60, a communication transceiver 62, a reference signal 64, a phase detector 66, and a receiver 68. The intelligent control 42 can also include memory for storing data related to the position of the mobile unit, and may also store other data related to the transmission and receiving of the RF signals.

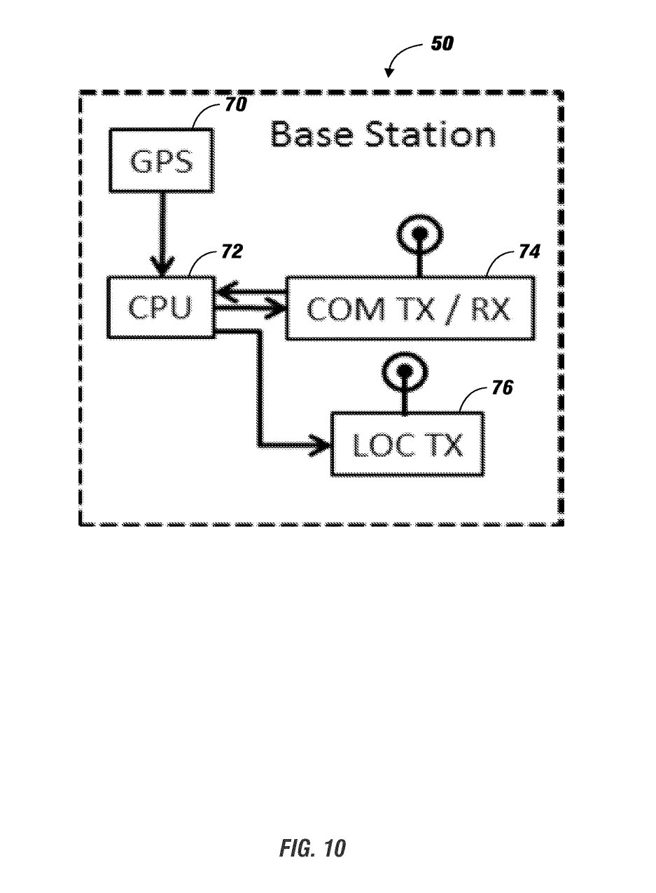

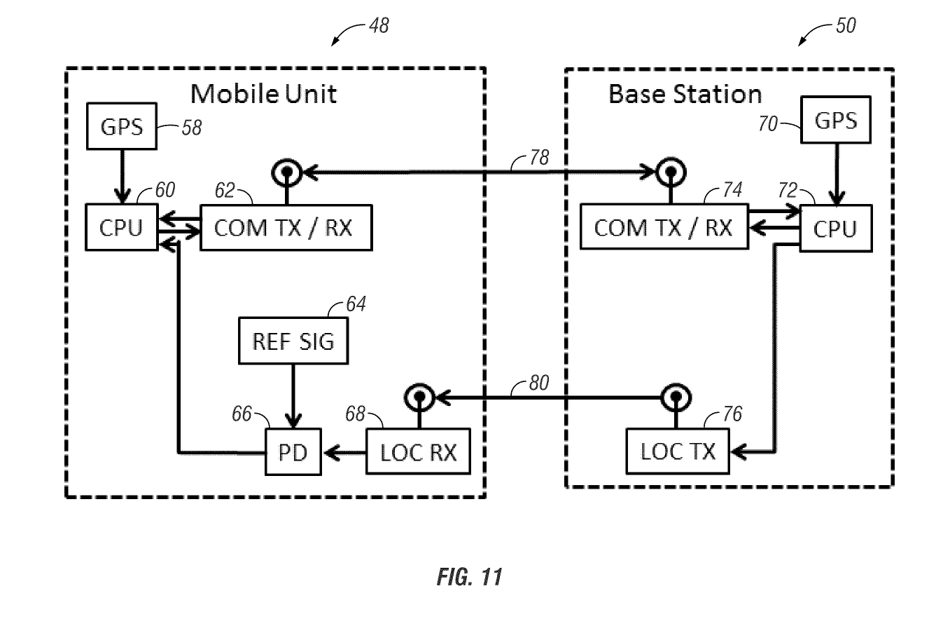

The components of an exemplary base unit 48 according to an embodiment of the positioning system 49 of the present invention are shown in FIG. 10. The base unit of FIG. 10 includes a standard GPS receiver 70, a control system or intelligent control 72, a communication transceiver 74, and a transmitter 76. A block diagram showing the interaction between a mobile unit 48 and active base unit 50 is shown in FIG. 11.

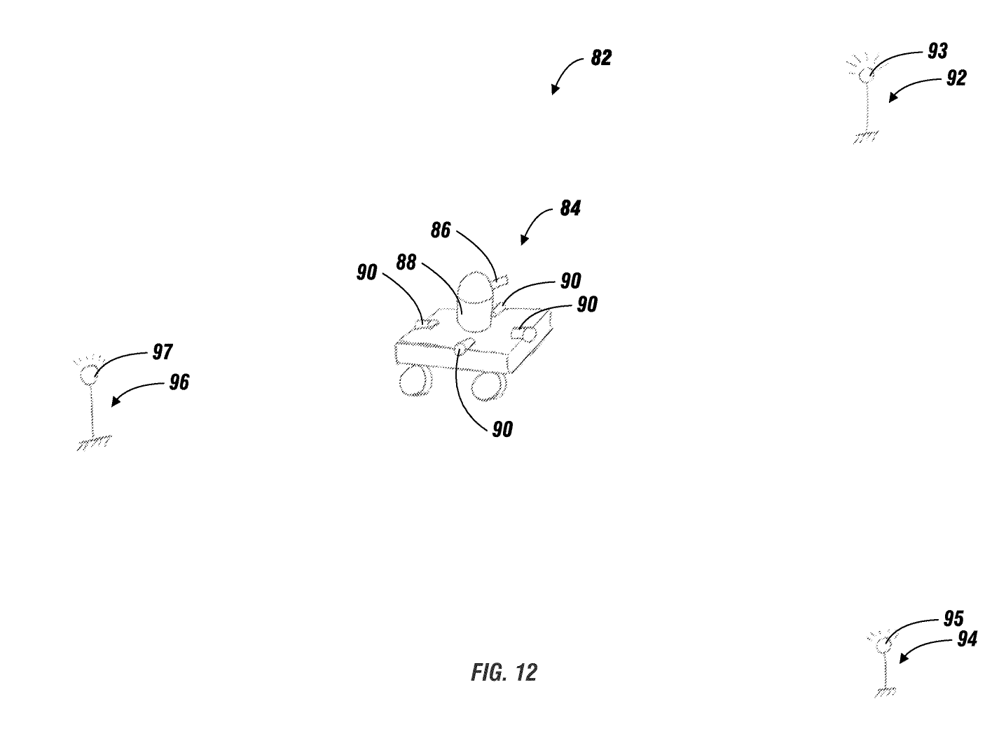

FIG. 12 is a schematic diagram illustrating the determination of a position of a mobile unit 84 by utilization of an optical positioning system 82 according to alternate embodiments of the present invention. The positioning system 82 may include a minimum of three base units, with no maximum number. It should be appreciated that a greater number of base units 92 may be used to increase the accuracy of the system 82 in determining the location of the mobile unit 84. According to some embodiments of the invention, base unit number one 92 comprising a mono-chromatic light source 93, base unit two 94 comprising a mono-chromatic light source 95, and base unit three 96, comprising a mono-chromatic light source 97 are fixed in location. Likewise, according to some embodiments of the invention, the mobile unit 84 comprises a narrow field camera 86 mounted to a two-axis gimbal 88, four fixed field wide angle cameras 90 located at the front, left and right sides and rear, and a control system or intelligent control 106. However, it is to be appreciated that any of the units may comprise more or less components, as needed.

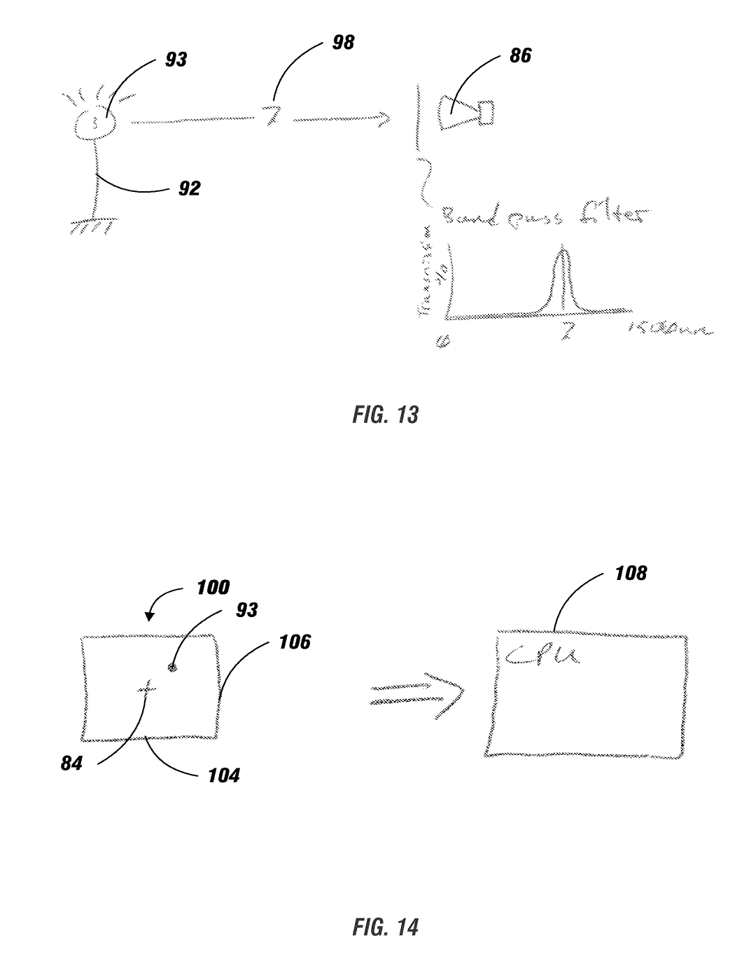

To determine the position of the mobile unit 84 according to embodiments of the positioning system 82, the following process may be used. The process utilizes a minimum of three ground based light sources to define a plane. Each base unit global location is known. Wide field cameras 90 are utilized to acquire the location of light sources 93, 95, and 97 with respect to mobile unit 84. FIG. 14 shows the camera plane 100 indicating the general location of light source 93. The mobile unit 84 is also referenced on the camera plane 100 with respect to base unit 92. The control system 108 utilizes a first axis 104 and a second axis 106 to generate coordinates of the base unit 92, which the narrow field camera 86 slews to via the gimbal 88 to gain a higher resolution angular position of the light source 93, 95 and 97 with respect to the mobile unit 84. FIG. 13 shows the camera 86 acquiring only one light wavelength 98 from the light source 93. The camera 86 utilizes a band pass filter to isolate the wavelength 98 from the background. Repeating the process for the base unit 94 and additional base unit 96 will give the control system 108 at least three pitch/yaw/roll solutions to locate the mobile unit 84 in space via simple triangulation.

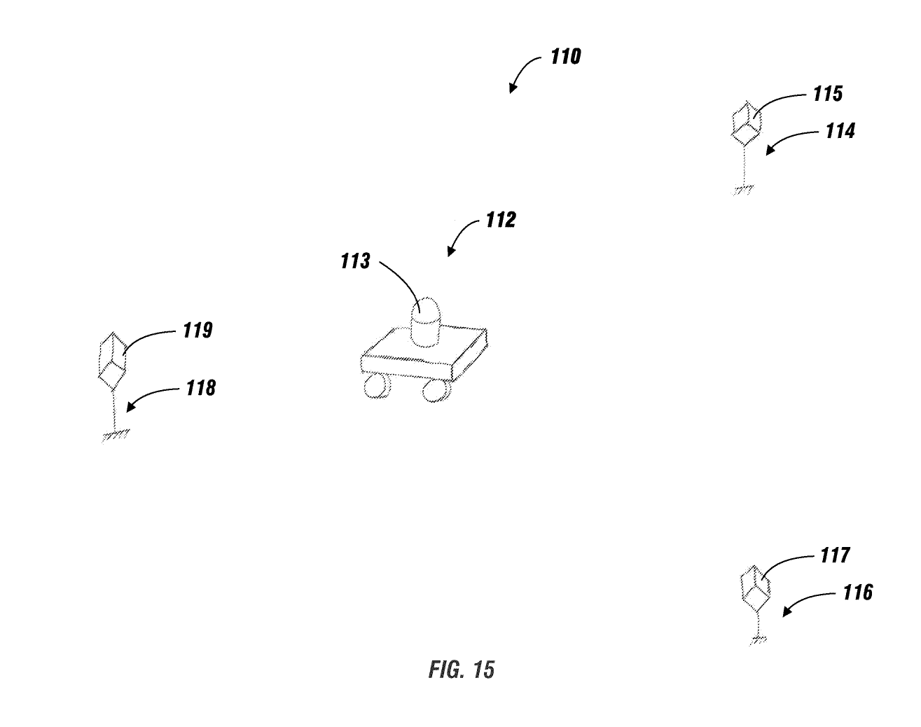

FIG. 15 is a schematic diagram illustrating the determination of a position of a mobile unit 112 by utilization of the radar positioning system 110 according to an alternate embodiment of the present invention. As noted, the positioning system 110, according to an embodiment, may include a minimum of three base units, with no maximum number. It should be appreciated that a greater number of base units may be used to increase the accuracy of system 110 in determining the location of the mobile unit 112. According to an embodiment of the present invention, a first base unit 114 comprising a radar reflector 115, second base unit 116 comprising a radar reflector 117, and third base unit 118 comprising a radar reflector 119 are fixed in location. Likewise, according to an embodiment of the invention, the mobile unit 112 comprises a radar unit 113. The radar unit 113 includes a radio wave transmitter, radio wave receiver, and a control system. However, it is to be appreciated that any of the units may comprise more or less components, as needed.

To determine the position of the mobile unit 112 according to the embodiment of the positioning system 110, the following process may be used. The process utilizes a minimum of three ground based radar reflectors to define a plane. Each base unit global location is known. As the mobile unit 112 moves the radar unit 113 rotates at a fixed speed. The radio wave transmitter (not shown) signal is reflected back from base unit reflector 115 to mobile unit 112. The control system 110 now knows where the mobile unit 112 is from base unit 114 via simple triangulation. Repeating the process for base unit 116 and base unit 118 will give control system 110 at least three XYZ coordinates to locate mobile unit 112 in space.

It is to be appreciated that the exemplary embodiments shown and described contemplate numerous variations, options, and alternatives, and are not to be limited to the specific embodiment shown and described herein. The foregoing description has been presented for purposes of illustration and description, and is not intended to be an exhaustive list or to limit the exemplary embodiments to precise forms disclosed. It is contemplated that other alternative processes obvious to those skilled in the art are considered to be included in the invention.

What is claimed is:

1. A positioning system, comprising:
a plurality of base units;
at least one mobile unit comprising an intelligent control and a frequency generator for generating a radio frequency reference signal;
wherein the radio frequency signal is transmitted between the at least one mobile unit and the plurality of base units; and
wherein a range is determined by the mobile intelligent control unit based on the phase difference between a reference radio frequency signal and a radio frequency location signal emanating from a stationary base unit.

2. The positioning system of claim 1, wherein the plurality of base units each comprise a frequency generator, transceiver and an intelligent control.

3. The positioning system of claim 2, wherein at least one mobile unit further comprises a transceiver and a phase detector.

4. The positioning system of claim 3, wherein the transceivers of the base units and mobile unit(s) receive and send the radio frequency signal between one another.

5. The positioning system of claim 4, wherein said base units further comprise a GPS receiver and the mobile unit further comprise a GPS receiver to acquire additional location data.

6. The positioning system of claim 1, wherein the plurality of base units comprises at least three base units.

7. The positioning system of claim 1, wherein said mobile unit is an autonomous vehicle.

8. The positioning system of claim 1, further comprising a tower at each base unit to position the base unit in the air such that signal blockage is mitigated.

9. A method of determining the position of a mobile unit, the method comprising:
providing a positioning system comprising a plurality of base units having known locations and at least one mobile unit;
transmitting a radio frequency signal from the at least one mobile unit to at least one of the base units;
returning the signal from the base unit to the mobile unit; and
determining a change in location of the mobile unit relative to the base unit based upon a phase shift in the radio frequency.

10. The method of claim 9, further comprising repeating the transmitting, returning, and determining steps with a radio frequency signal between the at least one mobile unit and the rest of the base units.

11. The method of claim 10, further comprising determining the position of the at least one mobile unit relative to the known locations of the base units based upon the combined phase shifts of the signals.

12. The method of claim 9, further comprising repeating the transmitting, returning, and determining steps to continually update the location of the at least one mobile unit relative to the base units.

13. The method of claim 9, wherein the number of base units comprises at least three base units having known locations.

14. The method of claim 9, further comprising initializing the location of the base units by transmitting a radio frequency between the base units prior to transmitting with the mobile unit.

15. The method of claim 14, further comprising designating one of the base units as a master base unit, wherein the master base unit transmits radio frequency signals with the other plurality of base units to initialize the locations thereof.

16. The method of claim 15, wherein the initialization step determines the distance between each of the base units.

17. A method of determining the location of a mobile unit, the method comprising:
providing a positioning system comprising a plurality of base units having known locations and each having a light source, and at least one mobile unit comprising one or more cameras;
obtaining light-based information from the base units with the one or more cameras of the mobile unit; and
determining the location of the mobile unit with the light-based information acquired from the base units.

18. The method of claim 17, wherein said step of obtaining light-based information comprises obtaining information from at least three base units to define a plane.

19. The method of claim 18, wherein said mobile unit comprises four fixed, wide angle cameras, and a narrow field camera mounted to a two-axis gimbal.

20. The method of claim 19, further comprising first obtaining location of the base units with the wide angle cameras, and then using the narrow field camera to determine the elevation from the base units.
